(19) United States
(12) Patent Application Publication
(10) Pub. No.: US 2025/0037423 A1
(43) Pub. Date: Jan. 30, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: HIDEO NORO, Tokyo (JP); KOJI MAKITA, Kanagawa (JP); TOMONORI YAZAWA, Kanagawa (JP)

(21) Appl. No.: 18/884,804

(22) Filed: Sep. 13, 2024

Related U.S. Application Data
(63) Continuation of application No. PCT/JP2023/007959, filed on Mar. 3, 2023.

(30) Foreign Application Priority Data
Mar. 23, 2022 (JP) 2022-047586

(51) Int. Cl. G06V 10/762; G06V 10/764; G06V 40/16

(52) U.S. Cl. CPC G06V 10/762; G06V 10/764; G06V 40/168; G06V 40/172

(57) ABSTRACT

An information processing apparatus reduces noise included in a set of data related to a specific object by realizing a set of data of only an object A included in a cluster A by adding another cluster to a cluster having the highest reliability.

### CROSS-REFERENCE TO RELATED APPLICATIONS

This application is a Continuation of International Patent Application No. PCT/JP2023/007959, filed Mar. 3, 2023, which claims the benefit of Japanese Patent Application No. 2022-047586, filed Mar. 23, 2022, both of which are hereby incorporated by reference herein in their entirety.

### BACKGROUND OF THE INVENTION

### Field of the Invention

The present invention relates to a data collection technique.

### Background Art

PLT 1 discusses a technique for extracting an image of an object related to a search keyword from a cluster including images that are highly likely to be of the object related to the keyword.

### CITATION LIST

### Patent Literature

PLT 1: Publication of Japanese Patent No. 6314071

### SUMMARY OF THE INVENTION

The present invention is directed to reduction of noise included in a set of data related to a specific object. In order to solve the above-described issue, an information processing apparatus includes at least one memory storing instructions, and at least one processor that, upon execution of the stored instructions, cause the at least one processor to acquire a plurality of elements, classify the acquired elements into a plurality of clusters based on a similarity between the elements, select a first cluster related to a predetermined object based on a first index calculated from elements included in the classified clusters, select a second cluster based on a second index calculated from the first cluster and the elements included in the classified clusters, specify a marge element to be merged, among the acquired elements, based on the second cluster and the first cluster, and output a third cluster including the merge element, an element included in the first cluster, and an element included in the second cluster.

Further features of the present invention will become apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus.

FIG. 2 is a block diagram illustrating a functional configuration example of the information processing apparatus.

FIG. 3 is a flowchart illustrating processing to be performed by the information processing apparatus.

FIG. 4 is an activity diagram illustrating processing to be performed by the information processing apparatus.

FIG. 5 is a schematic diagram illustrating an example of data and order information.

FIG. 6 is an activity diagram illustrating processing to be performed by the information processing apparatus.

FIG. 7A is a schematic diagram illustrating an example of relationship among data.

FIG. 7B is a schematic diagram illustrating an example of relationship among data.

FIG. 8 is an activity diagram illustrating processing to be performed by the information processing apparatus.

FIG. 9 is an activity diagram illustrating processing to be performed by the information processing apparatus.

FIG. 10 is an activity diagram illustrating processing to be performed by the information processing apparatus.

FIG. 11 is a table illustrating examples of elements and indices.

FIG. 12 is an activity diagram illustrating processing to be performed by the information processing apparatus.

FIG. 13 is a schematic diagram illustrating an example of relationship among data.

FIG. 14 is an activity diagram illustrating processing to be performed by the information processing apparatus.

FIG. 15 is an activity diagram illustrating processing to be performed by the information processing apparatus.

FIG. 16 is a schematic diagram illustrating an example of conversion processing on an image.

### DESCRIPTION OF THE EMBODIMENTS

In existing hierarchical clustering that is one of methods of grouping the same kind of images in a cluster, operation is performed such that a certain element (image) is included in a cluster having the highest possibility. Therefore, for example, in a case where a cluster A indicates an object A and a cluster B indicates an object B, an element (image) similar to the object B but indicating the object A is included in the cluster B. Further, in the case of the hierarchical clustering, an element indicating the object B may be included in the cluster indicating the object A due to repetition of integration with a similar cluster. In the present invention, to eliminate the object B included in the cluster A and realize a data set of only the object A, another cluster is added to a cluster having the highest reliability.

In the following, among collected data, an element to be extracted is referred to as a signal element, and an element to be removed is referred to as a noise element. In the case of PLT 1, the image of the object related to the keyword is a signal element, and other images are noise elements.

In the following, preferred exemplary embodiments of the present invention are described with reference to accompanying drawings.

### First Exemplary Embodiment

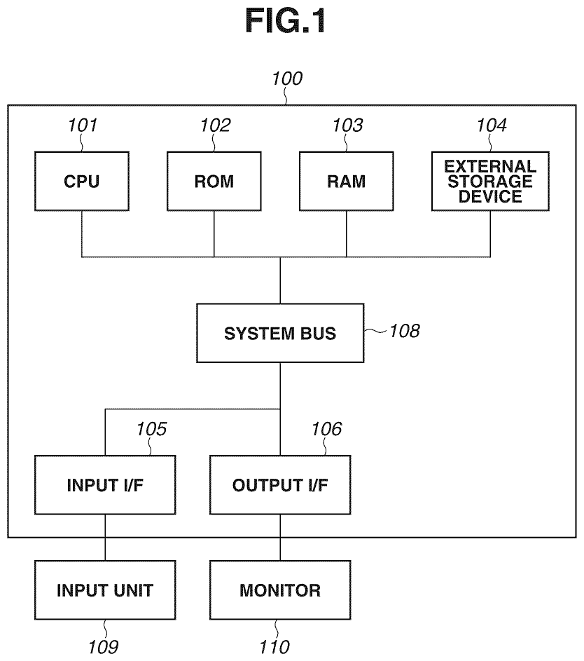

FIG. 1 is a diagram illustrating an example of a hardware configuration of an information processing apparatus according to a first exemplary embodiment. An information processing apparatus 100 collects data highly related to a designated query to generate a cluster for each object.

A central processing unit (CPU) 101 is a central processing unit that controls the whole of the information processing apparatus 100. A read only memory (ROM) 102 is a read only memory that stores programs and parameters not requiring a change. A random access memory (RAM) 103 is a random access memory that temporarily stores programs and data supplied from an external apparatus and the like. An external storage device 104 is a storage device, such as a hard disk and a memory card, fixedly installed on the information processing apparatus 100. The external storage device 104 may include a flexible disc (FD), an optical disc such as a compact disc (CD), a magnetic or optical card, an integrated circuit (IC) card, a memory card, and the like that are attachable to and detachable from the information processing apparatus 100. Functions and processing of the information processing apparatus 100 described below are realized when the CPU 101 reads out the programs stored in the ROM 102 and the external storage device 104 and executes the programs.

An input interface (I/F) 105 is an interface with an input unit 109, such as a pointing device and a keyboard, to receive an operation of a user and input data. An output I/F 106 is an interface with a monitor (display device) 110 to display data held by the information processing apparatus 100 and supplied data. A data output method is not limited to the display device such as a monitor, and may be an output device, such as a speaker, that outputs audio. A system bus 108 is a transmission path communicably connecting the units 101 to 106.

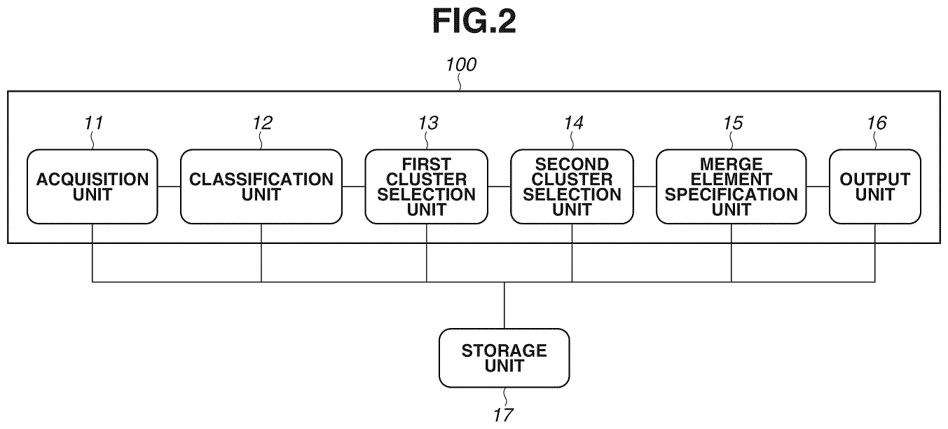

FIG. 2 is a block diagram illustrating a functional configuration example of the information processing apparatus 100 according to the present exemplary embodiment.

The information processing apparatus 100 outputs a third cluster of extracted signal elements, and a result is output from an output unit 16. In order to actually implement the present invention, means for using the output result is necessary. It is assumed that the result is output to, for example, a display device or an analysis device for face authentication or the like, but description of the means for using the result is omitted because the application is not limited.

An acquisition unit 11 acquires data to be processed, namely, data related to a specific object. More specifically, the acquisition unit 11 acquires a large number of face images considered to be of the same person. For example, in a person search system using a monitoring camera, face images of persons resembling each other that are obtained by designating a query image and inputting a face image of a person to be searched for may be data to be processed. Alternatively, as discussed in PLT 1, data extracted by search using a keyword, such as a name, may be acquired from the Internet. The images (data) acquired by the acquisition unit 11 may also be referred to as elements in the subsequent processing.

In the present exemplary embodiment, face images are acquired as elements, but data to be handled is not limited to face images, and a set of elements (data) considered to be of the same kind are handled. Other examples of the elements considered to be of the same kind include photographs of a printed document or a handwritten document of a specific character (e.g., “A”), and images obtained by imaging a specific object (e.g., automobile of a specific model). Images obtained by performing conversion, such as enlargement/contraction/rotation, color correction and the like, on these images and clipping images in appropriate sizes therefrom may be used as the elements. As described above, the data collection method is not limited, and acquired data includes data including the specific object and other data (not including the specific object) in a mixed manner.

In other words, the elements are classified into signal elements and noise elements. More specifically, the signal elements are elements to be extracted and are face images of the same person. The noise elements are face images of persons different from the person of the signal elements, and the like. For example, in the above-described person search system, most of face images (elements) obtained by inputting “face image of Mr. A” are considered as “face images of Mr. A” (signal elements). Other images, namely, “face images of persons other than Mr. A (resembling Mr. A)”, face illustrations, and images other than face images are the noise elements.

A classification unit 12 classifies the acquired elements (images) into a plurality of clusters based on similarity among the elements. In other words, the classification unit 12 performs clustering on a set of predetermined elements acquired by the acquisition unit 11. Although details are described below, all of the elements are not clustered, but only elements having a strong relationship are extracted as one cluster or a plurality of clusters.

A first cluster selection unit 13 selects a core cluster (first cluster) related to a predetermined object among the classified clusters, based on a first index calculated from the elements included in the clusters. A cluster that is highly likely to include only the elements related to the predetermined object, namely, the signal elements is referred to as a core cluster in the following. Among the clusters classified by the classification unit 12, one cluster considered to include only the signal elements is extracted as a core cluster. Details are described below.

A second cluster selection unit 14 specifies a merge cluster (second cluster) based on a second index calculated from the elements included in the core cluster (first cluster) and the elements included in the plurality of classified clusters. In other words, among the plurality of classified clusters, a cluster similar to the selected cluster is specified. The merge cluster is a cluster different from the core cluster and is a cluster to be merged with the core cluster. A cluster similar to the core cluster is specified as a merge cluster. Details are described below.

A merge element specification unit 15 specifies a marge element to be merged, among the acquired elements, based on the merge cluster (second cluster) and the core cluster (first cluster). In other words, among the elements included in neither the core cluster nor the merge cluster, an element having a similarity with the core cluster or the merge cluster by a predetermined value (third threshold) or more is specified as a merge element. Details are described below.

The output unit 16 outputs a cluster (third cluster) including the merge element, the elements included in the core cluster (first cluster), and the elements included in the merge cluster (second cluster). In other words, the elements of the core cluster, the elements of the merge cluster, and the merge element are output as a noise-removed element list. Details are described below.

A storage unit 17 is the RAM 103, and stores as appropriate information necessary for performing the above-described processing of the acquisition unit 11 to the output unit 16.

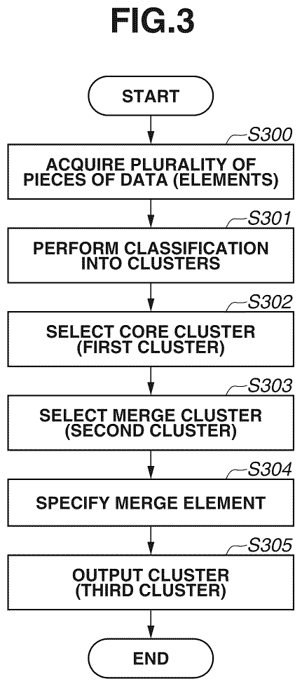

The processing to be performed by the information processing apparatus 100 is described below. FIG. 3 is a flowchart illustrating the processing to be performed by the information processing apparatus 100. Processing corresponding to each step of the flowchart described in the present exemplary embodiment may be realized by software by using a CPU, or may be realized by hardware such as an electronic circuit.

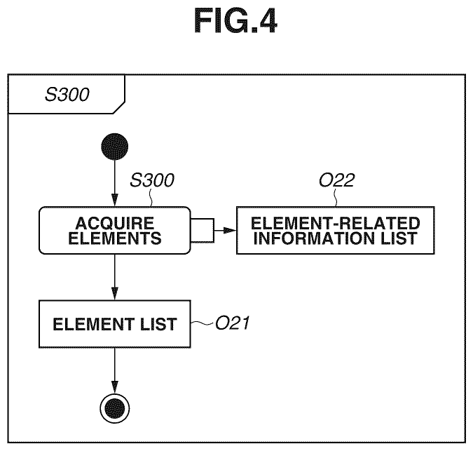

First, in step S300, the acquisition unit 11 acquires a plurality of pieces of data (elements). This flow will be described with reference to FIG. 4.

In step S300, the acquisition unit 11 acquires a plurality of pieces of data (elements). A result of the acquisition is output as an element list O21. An element is an image itself, and is typically an image loaded on a memory or an image file name. In a case where information related to the elements is necessary, an element-related information list O22 is output. Examples of the element-related information include order information. The order information is a number 1, 2, . . . assigned to images in the order that is most likely to be of Mr. A when “face image of Mr. A” is acquired. Alternatively, the element-related information may be certainty information. The certainty information is a degree of certainty as “face image of Mr. A” represented by, for example, a numerical value between 0 and 1 both inclusive. The order information and the certainty information are output depending on a target for which a set of elements is acquired by the acquisition unit 11. Although the output information is different depending on the target, for example, in the case of the person search system, if a degree of resemblance to a face image of a person to be searched for is output, the degree of resemblance serves as the certainty information. Further, in a case where face images are output in descending order of the degree of similarity, the output order serves as the order information.

Although, in the present exemplary embodiment, a case where the element-related information list includes the order information is described, in a case of acquiring the order information in a case where only the certainty information is obtainable, for example, the elements that are numbered from 1 in descending order of the certainty information may be used. The certainty information and the order information are not necessarily unique, and a plurality of elements may have the same value. The element-related information is used in processing on a subsequent stage, but if the element-related information is not used, the element-related information list O22 may not be output. A diagram element starting with a letter “O” is data to be handled in input or output of each processing, and is stored in the storage unit 17.

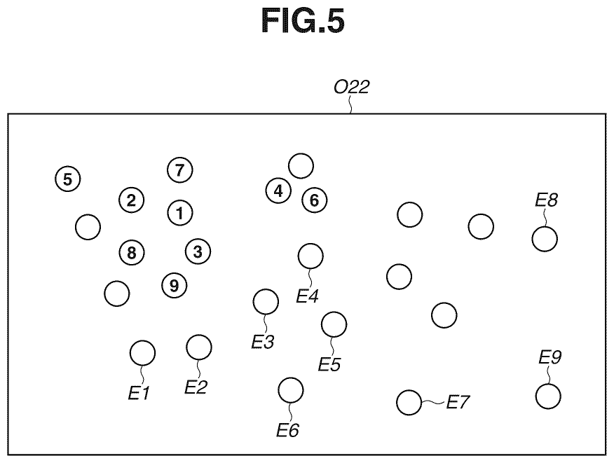

FIG. 5 illustrates the element-related information list O22. Each circle in the drawing indicates an element. A number given in the circle is the order information from 1 to 9. Illustration of the number of 10 or greater is omitted. For the following description, E1 to E9 are assigned to some elements.

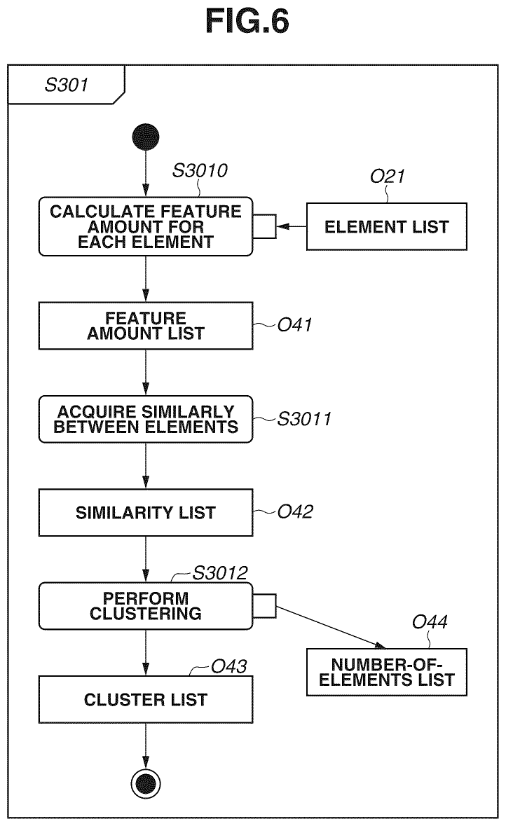

Refer back to the flowchart in FIG. 3. In step S301, the classification unit 12 extracts elements having a strong relationship as a cluster, from the elements acquired by the acquisition unit 11. A diagram of this activity is illustrated in FIG. 6.

In step S3010, the classification unit 12 extracts a feature (first feature amount) from data (element) based on a first feature extraction method. The feature amounts are calculated for the respective elements in the element list O21, and are output as a feature amount list O41. The first feature extraction method may be an optional method. For example, a feature vector is acquired from a feature extraction trained model by using Deep Residual Learning for Image Recognition (ResNet) of a deep neural network.

In step S3011, the classification unit 12 acquires a similarity by comparing the features of the elements. More specifically, a similarity between two elements in the feature amount list O41 is calculated in a round-robin manner, and a similarity list O42 is output. Here, the similarity is a value within a range from −1 to 1, but is not limited thereto. As a method of calculating the similarity, for example, a cosine similarity between feature amounts can be used.

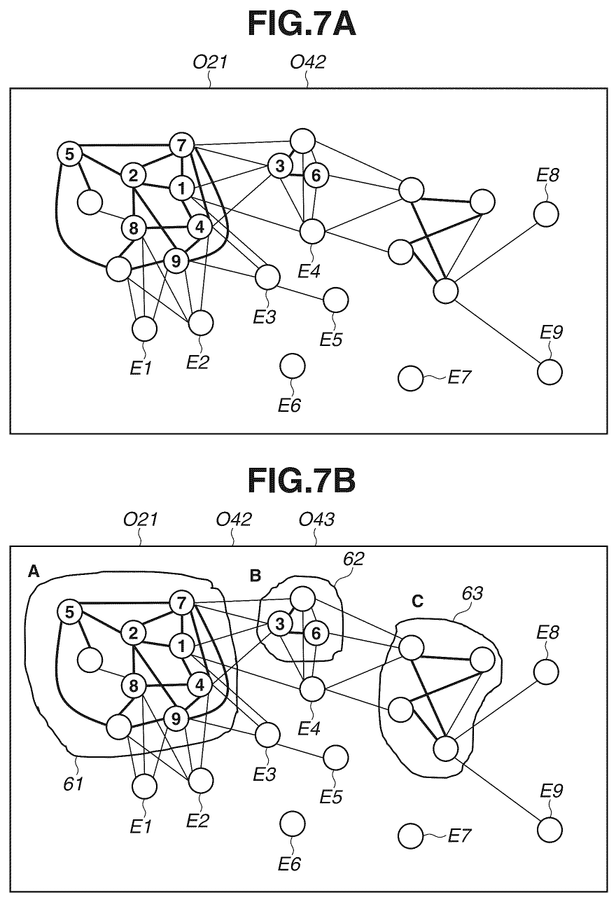

FIG. 7A is a schematic diagram illustrating a relationship of the similarities among the elements. FIG. 7A illustrates the elements represented by circles, and line segments each connecting elements. In other words, FIG. 7A is a diagram illustrating the content of the similarity list O42 superimposed on the element list O21. In the drawing, two elements having a similarity that is equal to or greater than a predetermined threshold TH1 are connected by a solid line, and two elements having a similarity that is a predetermined threshold TH2 (>TH1) are connected by a thick line.

In step S3012, the classification unit 12 extracts elements having a similarity that is equal to or greater than a predetermined threshold to generate a cluster. That is, clustering is performed based on the similarity list O42. In other words, two optional elements included in one cluster have a similarity that is equal to or greater than the threshold (TH2). A result of cluster classification is output as a cluster list O43.

FIG. 7B is a schematic diagram illustrating a relationship of the similarities among the elements. FIG. 7B is a diagram illustrating the cluster list O43 superimposed on the element list O21 and the similarity list O42. In this example, three clusters that are a cluster A61, a cluster B62, and a cluster C63 are extracted.

Further, the classification unit 12 also calculates the number of elements indicating the number of elements included in each of the clusters, and outputs the numbers of elements as a number-of-elements list O44. However, if the number-of-elements list O44 is not used in processing on the subsequent stage, the number-of-elements list O44 may not be output.

Refer back to the flowchart in FIG. 3. In step S302, the first cluster selection unit 13 selects one core cluster (first cluster) based on information included in the elements included in each of the clusters. The cluster selected here is a cluster considered to include only signal elements in the cluster list O43.

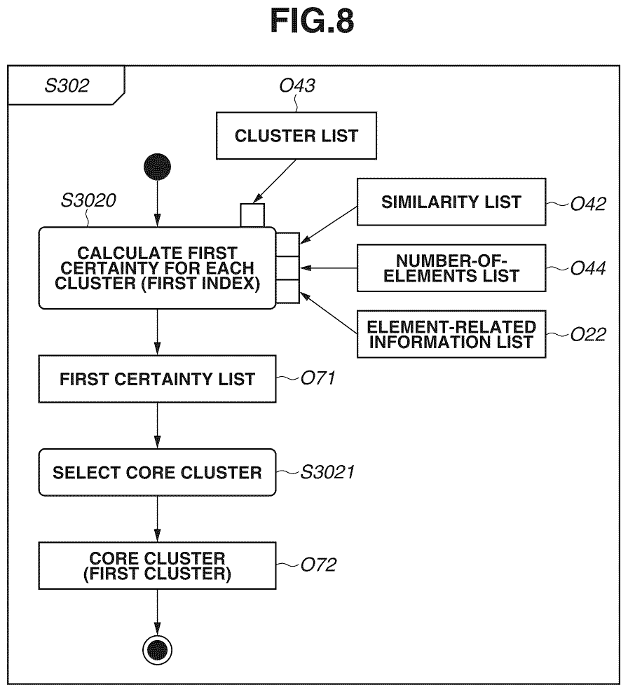

FIG. 8 is a diagram of activity in the first cluster selection unit 13. Each of the clusters in the cluster list O43 has a strong relationship and a high similarity that is equal to or greater than the threshold TH2, and is expected to be a set of the elements indicating “apparently Mr. A” and “apparently Mr. A wearing a mask”. A representative cluster of the element list O21 is to be selected from these clusters. In other words, the cluster indicating “apparently Mr. A” is to be selected. Since the element list O21 is a set of elements of persons resembling Mr. A, it is considered that the cluster indicating “apparently Mr. A” can be selected by performing selection based on the following criteria.
Policy 11) Cluster including elements having a high similarity
Policy 12) Cluster including a large number of elements
Policy 13) Cluster including a large number of elements having smaller numbers in the order information (element having high relevance)

Thus, in step S3020, the first cluster selection unit 13 calculates a first certainty for each cluster based on the similarity between the elements, the number of elements, and a degree of relevance. An example in which the certainty is calculated based on the cluster list, the similarity list, the number-of-elements list, and the element-related information list is described. In other words, the first certainty (first index) is a certainty indicating a possibility that a predetermined object is included. Not all of the policies are necessarily used, but a cluster conforming to a larger number of policies is more desirable. The first certainty of each of the clusters in the cluster list O43 is calculated according to the above-described policies 11 to 13. The first certainty (first index) has, for example, a value within a range from 0 to 1, and a larger value indicates that the cluster is more “apparently Mr. A”.

A method of calculating the first certainty is described below.

When

$${α}_{1} + {β}_{1} + {γ}_{1} = 1$$

the following equations are established.

$${CC}_{1} = \frac{{\sum }_{i , j ∈ {S}_{ele}} {sim}_{ij}}{{n ( {s}_{ele} )}^{{P}_{2}}} \qquad ( Equation 1 )$$

$${CC}_{2} = \frac{n ( {s}_{ele} )}{n ( {s}_{all} )} \qquad ( Equation 2 )$$

$${CC}_{3} = \frac{{\sum }_{i ∈ {S}_{ele}} \frac{1}{{r}_{i}}}{{\sum }_{j ∈ {S}_{all}} \frac{1}{{r}_{j}}} \qquad ( Equation 3 )$$

$$CC = {α}_{1} \cdot {CC}_{1} + {β}_{1} \cdot {CC}_{2} + {γ}_{1} \cdot {CC}_{3} \qquad ( Equation 4 )$$

where, Sₑₗₑ is a set of subscripts of the elements included in the cluster, Sₐₗₗ is a set of subscripts of all elements, simᵢⱼ is a similarity between an element i and an element j, n(S) is the number of elements in a set S, n(Sₑₗₑ) is the number of elements in the cluster, n(Sₐₗₗ) is the number of all elements, ₙPₖ is a total number of permutations obtained by selecting k elements from n elements, and rᵢ is the order information of the element i.

For example, a first certainty CC1 in the case of the policy 11, a first certainty CC2 in the case of the policy 12, and a first certainty CC3 in the case of the policy 13 are respectively represented by equations 1 to 3. The equations described here are illustrative, and equations are not specifically limited as long as the equations represent evaluation values of the policies 11 to 13.

A first certainty CC of each of the clusters is calculated from the values of CC1 to CC3. An example of calculation of the first certainty CC is represented by equation 4. Note that α1, β1, and γ1 are predetermined values. In the equation 4, the values of CC1 to CC3 based on the policies 11 to 13 are used; however, an index based on another policy may be added. The first certainties CC of the respective clusters are output as a first certainty list O71.

As an example, the first certainties CC of the cluster A61, the cluster B62, and the cluster C63 are determined using the above-described equations. To simplify the calculation, a similarity indicated by the thick line is set to 0.7, and a similarity indicated by the thin line is set to 0.3. In addition, to simplify the calculation, the search order information of 10 or larger is all handled as 10.

First, the first certainty CC of the cluster A61 is determined. The number of elements in the cluster A61 is 9, the number of thick lines connecting the elements in the cluster A61 is 16, and the number of thin lines is 1, and thus CC1=0.319, CC2=0.360, and CC3=0.571 are calculated. Further, when α1=0.3, β1=0.1, and γ1=0.6 are set, CC=0.474 (first certainty of cluster A61) is obtained.

Likewise, the first certainty CC of the cluster B62 is obtained as CC=0.263 (first certainty of cluster B62). The first certainty CC of the cluster C63 is obtained as CC=0.225 (first certainty of cluster C63).

In step S3021, the first cluster selection unit 13 selects a cluster having the first certainty that is equal to and greater than the first threshold as a core cluster (first cluster), based on the first certainty. Alternatively, the first cluster selection unit 13 selects a cluster having the greatest first index as a core cluster. The first cluster selection unit 13 selects, as a core cluster O72, a cluster having the first certainty having the greatest value from the first certainty list O71. In a case where a plurality of clusters has the first certainty having the greatest value, one of the plurality of clusters or a union of the plurality of clusters is selected as the core cluster O72. In this example, the cluster A61 is selected because the cluster A61 has the greatest first certainty of 0.474.

In a case where the greatest first certainty does not exceed the first threshold, the processing may end without selecting a core cluster. In this case, the processing returns to the collection of elements or the extraction of features.

Refer back to the flowchart in FIG. 3. In step S303, the second cluster selection unit 14 specifies a cluster similar to the core cluster as a merge cluster (second cluster).

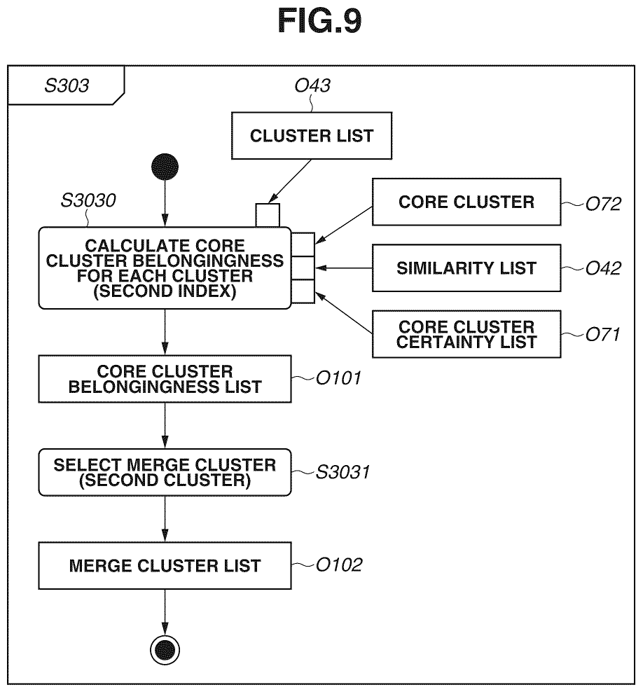

FIG. 9 illustrates processing to be performed by the second cluster selection unit 14 and a flow of data.

It can be specified whether the cluster is a merge cluster, for example, based on the following criteria.
Policy 21) Cluster including a large number of element pairs having a high similarity (similarity that is equal to or greater than a predetermined value) among the element pairs of the elements in the core cluster and the elements included in the cluster
Policy 22) Cluster having a high first certainty of the cluster

The above-described policies are examples for determining whether the cluster is similar to the core cluster, and another policy may be used. In other words, a merge cluster (second cluster) is selected by calculating a core cluster belongingness (second index) that is an index indicating a similarity between the core cluster (first cluster) and each of the clusters other than the core cluster. Since the second index for each of the clusters other than the core cluster is calculated, the clusters to be processed may also be referred to as target clusters. In the following specific example, the target clusters are a cluster B and a cluster C.

In step S3030, the second cluster selection unit 14 calculates a core cluster belongingness for each cluster, based on the elements included in each of the clusters and the elements included in the core cluster. The core cluster belongingness of each of the clusters in the cluster list O43 is calculated according to the above-described policies 21 and 22. The core cluster belongingness has, for example, a value within a range from 0 to 1, and a larger value indicates that the cluster is more “similar to the core cluster”.

For example, the core cluster belongingness corresponding to the policy 21 is denoted by CB1, and the core cluster belongingness corresponding to the policy 22 is denoted by CB2. The following equations 5 to 8 represent an example of a method of calculating the core cluster belongingness. In the equations, α2, β2, and TH3 are predetermined values. Note that equations are not specifically limited as long as the equations represent evaluation values of the policies 21 and 22.

$${N}_{sim} = n ( \{ {sim}_{ij} \vert {sim}_{ij} \geq {TH}_{1} , i ∈ {S}_{ele} , j ∈ {S}_{core} , i < j \} )$$

$${α}_{2} + {β}_{2} = 1 \qquad ( Equation 5 )$$

$${CB}_{1} = U ( {N}_{sim} - {TH}_{3} ) \cdot \frac{{N}_{sim}}{n ( {S}_{ele} ) \cdot n ( {S}_{core} )} \qquad ( Equation 6 )$$

$${CB}_{2} = CC \qquad ( Equation 7 )$$

$$CB = {α}_{2} \cdot {CB}_{1} + {β}_{2} \cdot {CB}_{2} \qquad ( Equation 8 )$$

where, Sₑₗₑ is a set of subscripts of the elements included in the cluster, S_{core} is a set of subscripts of all elements, simᵢⱼ is a similarity between an element i and an element j, n(S) is the number of elements in a set S, n(Sₑₗₑ) is the number of elements in the cluster, n(S_{core}) is the number of all elements, Nₛᵢₘ is the number of elements having a similarity that is equal to or greater than TH₁ among the similarities of the elements of the cluster and the core cluster, U(x) is a step function (0 when x<0, 1 when x≥0), and CC is the core cluster certainty of the cluster.

A core cluster belongingness CB (second index) of each of the clusters is calculated from the values of CB1 and CB2. When the core cluster belongingness CB with respect to the core cluster A is calculated for the cluster B and the cluster C, CB=0.160 is calculated for the cluster B, and CB=0.023 is calculated for the cluster C. In the equation 8, the values of CB1 and CB2 based on the policies 21 and 22 are used; however, an index based on another policy may be added. The core cluster belongingness CB of the respective clusters are output as a core cluster belongingness list O101.

The processing in step S3030 is described in more detail with reference to the above-described equations and FIGS. 7A and 7B. First, the core cluster belongingness CB of the cluster B62 is determined. Nsim denotes the number of solid lines connecting the elements in the cluster A61 and the elements in the cluster B62 illustrated in FIG. 7B. It can be read as Nsim=4 from FIG. 7B. In a case where Nsim is small, the relationship between the clusters is not necessarily large, and thus the core cluster belongingness CB1 is set to zero. This is represented by a unit step function in equation 5. When TH3=3 is set, Nsim≥TH3 is established, and CB1=0.148 is obtained from the equation 6.

The core cluster belongingness CB2 is equal to the first certainty of the cluster B62, and is 0.263. When α2=0.9 and β2=0.1 are set, 0.160 is obtained as the core cluster belongingness CB of the cluster B62. In other words, from the equation 8, CB=0.160 (core cluster belongingness of cluster B62) is calculated.

Subsequently, the core cluster belongingness CB of the cluster C63 is determined. No solid line connects the elements in the cluster A61 and the elements in the cluster C63, and thus Nsim=0 is calculated from the equation 5. Since the value of the unit step function in the equation 6 is zero, CB1=0 is calculated from the equation 6. The core cluster belongingness CB2 is equal to the first certainty of the cluster C63, and is 0.225 from the equation 7. Based on the foregoing, when the core cluster belongingness CB of the cluster C63 is determined using the equation 8, 0.023 is calculated. In other words, the core cluster belongingness of the cluster C with respect to the core cluster A is calculated as CB=0.023 (core cluster belongingness of cluster C63). The second cluster selection unit 14 put together the core cluster belongingness of the respective clusters into a list, and outputs the core cluster belongingness list O101. Since the cluster A is the core cluster, calculation of the core cluster belongingness can be omitted.

In step S3031 illustrated in FIG. 9, the second cluster selection unit 14 selects a cluster having the core cluster belongingness greater than the second threshold, as a merge cluster (second cluster), based on the core cluster belongingness (second index) calculated for each of the plurality of clusters. In the core cluster belongingness list O101, a cluster having the core cluster belongingness that is equal to or greater than a second threshold TH4 is specified as a merge cluster.

When the threshold TH4=0.1 is set, only the cluster B62 is specified as a merge cluster from the above-described calculation results. Generally, a plurality of clusters can be specified as merge clusters; however, depending on the value of the core cluster belongingness, only one cluster or no cluster is specified in some cases. The cluster specified as a merge cluster is output as a merge cluster list O102.

Refer back to the flowchart illustrated in FIG. 3. In step S304, the merge element specification unit 15 specifies, as a merge element, an element similar to the core cluster among the elements included in neither the merge cluster nor the core cluster. The merge element specification unit 15 determines the similarity between each of the clusters and the core cluster as the index (second index) indicating the core cluster belongingness. And the merge cluster specification unit 14 specifics a merge cluster from the value of the index determined by the merge element specification unit 14. The merge element specification unit 15 determines a similarity between each of the elements and a cluster of interest (core cluster or merge cluster) as an index (third index) indicating a cluster belongingness, and specifies a merge element from the value of the index. In this example, an element having the belongingness (third index) with respect to the core cluster or the merge cluster greater than a third threshold, as a merge element. An element having a statistic value (e.g., average value) of the third index that is equal to or greater than a reference value may be determined as a merge element without using the threshold.

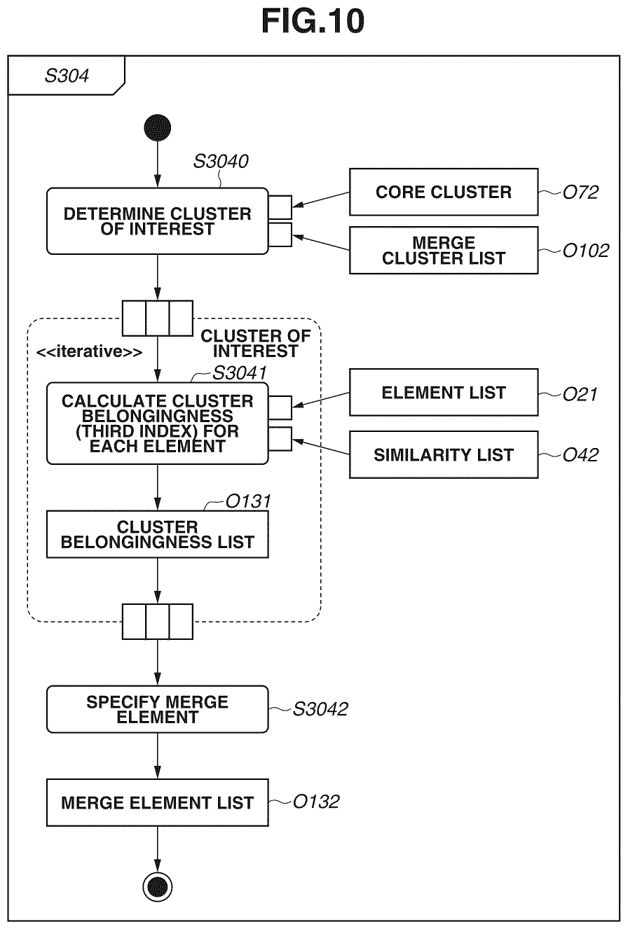

FIG. 10 illustrates processing to be by the merge element specification unit 15 and a flow of data. It can be specified whether the element is a merge element, for example, based on the following criterion.
Policy 31) Element having a high similarity to a large number of (predetermined number or more of) elements in the cluster of interest

The above-described policy is an example for determining whether the element is similar to the cluster of interest, and another policy may be used.

In step S3040, the merge element specification unit 15 determines a cluster of interest from the core cluster and the merge cluster. The cluster of interest is extracted from the core cluster O72 and the merge cluster list O102. Since the core cluster is the cluster A61, and the merge cluster is the cluster B62, these two clusters are transmitted to the subsequent processing. Processing in step S3041 is performed on each of the clusters of interest. First, processing is performed on the cluster A61.

In step S3041, the merge element specification unit 15 calculates a cluster belongingness of each of the elements included in neither the merge cluster nor the core cluster. The cluster belongingness has, for example, a value within a range from 0 to 1, and a larger value indicates that the element is more “similar to the cluster of interest”. For example, a cluster belongingness CBE1 corresponding to the policy 31 is represented by the following equations 9 to 11. In the equations, α3 and TH5 are predetermined values. Note that the described equations are illustrative, and equations are not specifically limited as long as the equations represent an evaluation value of the policy 31.

$${N}_{esim} = n ( \{ {sim}_{ij} \vert {sim}_{ij} \geq {TH}_{1} , i = {I}_{ele} , j ∈ {S}_{tgt} , i < j \} )$$

$${α}_{3} = 1 \qquad ( Equation 9 )$$

$${CBE}_{1} = U ( {N}_{esim} - {TH}_{5} ) \cdot \frac{{N}_{esim}}{n ( {S}_{tgt} )} \qquad ( Equation 10 )$$

$$CBE = {α}_{3} \cdot {CBE}_{1} \qquad ( Equation 11 )$$

where, Iₑₗₑ is a subscript of the element, S_{tgt} is a set of subscripts of the elements included in a target cluster, simᵢⱼ is a similarity between an element i and an element j, n(S) is the number of elements in a set S, n(S_{tgt}) is the number of elements in the target cluster, Nₑₛᵢₘ is the number of similarities that are equal to or greater than TH₁ among the similarities of the elements in the target cluster, and U(x) is a step function (0 when x<0, 1 when x≥0).

A cluster belongingness CBE is calculated from the value of CBE1. In the equation 11, only the value of CBE1 based on the policy 31 is used; however, an index based on another policy may be added. The cluster belongingness CBE of the respective elements with respect to the cluster of interest is output as a cluster belongingness list O131.

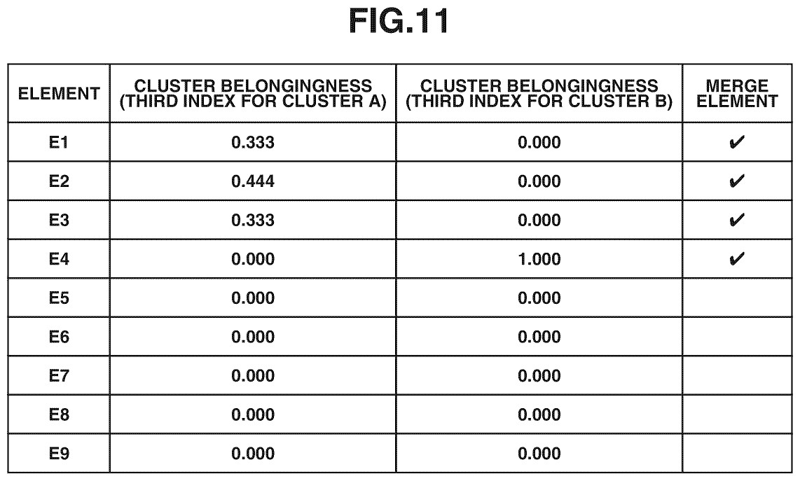

A state where a merge element is specified is described with reference to FIG. 7B. First, the cluster belongingness CBE of an element E1 with respect to the cluster A61 is determined. Nesim denotes the number of solid lines connecting the element E1 and the elements in the cluster A61 illustrated in FIG. 7B. It can be read as Nesim=3 from FIG. 7B. Further, the number of elements in the cluster A61 is 9. In a case where Nesim is small, the relationship between the element E1 and the cluster A61 is not large, and thus the cluster belongingness CBE1 is determined to be zero. This is represented by the unit step function in the equation 9. When TH5=3 is set, Nesim≥TH5 is established, and thus CBE1=0.333 is obtained from the equation 10. Then, 0.333 is obtained as the cluster belongingness CBE from the equation 11. In a similar manner to CBE=0.333 (cluster belongingness of element E1 to cluster A61), the cluster belongingness of respective elements E2 to E9 with respect to the cluster A61 is determined, and is output as the cluster belongingness list O131 (see FIG. 11). After the processing on the cluster A, similar processing is performed on the cluster B, and the cluster belongingness list O131 is output (see FIG. 11).

Next, in step S3042, a merge element is specified from the result of the cluster belongingness list O131. If an element has the cluster belongingness with respect to any of the clusters of interest that is equal to or greater than a predetermined threshold TH6, the element is specified as a merge element. There may be a plurality of the elements satisfying the condition. When the threshold TH6=0.3 is set, four elements E1, E2, E3, and E4 are specified as merge elements (see FIG. 11). The four elements specified as merge elements are output as a merge element list O132.

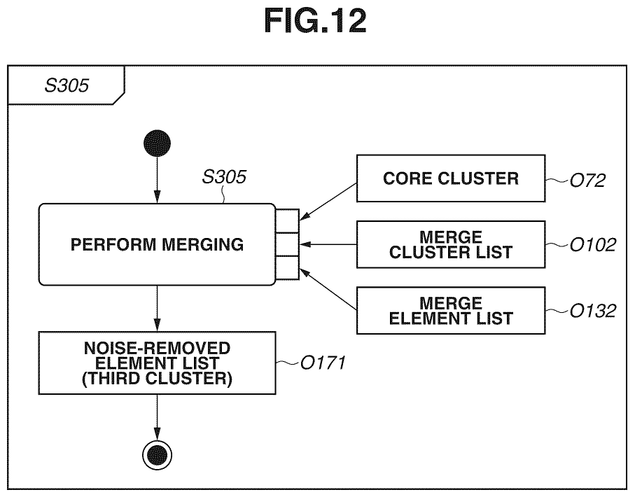

Refer back to FIG. 3. In step S305, the output unit 16 outputs a cluster from which noise is removed. In other words, a noise-removed element list is output. This is a list of elements considered to be the signal elements. FIG. 12 illustrates a flow of processing to be performed by the output unit 16. In step S305, the output unit 16 collects the elements of the core cluster O72, the elements of the merge cluster, and the merge element, and outputs these elements as a noise-removed element list O171 (third cluster). The elements of the merge cluster may be the elements included in the merge cluster extracted from the merge cluster list O102.

The operation is described with reference to FIG. 7B.

The elements of the core cluster are elements included in the core cluster. In FIG. 7B, the core cluster is the cluster A61. Nine elements included in the cluster A61 are extracted.

The elements of the merge cluster are elements included in the merge cluster. In FIG. 7B, the merge cluster is only the cluster B62. Three elements included in the cluster B62 are extracted.

The merge element is an element to be merged to the core cluster that has been specified based on the third index, among the elements included in neither the merge cluster nor the core cluster. In FIG. 7B, the merge elements are four elements E1, E2, E3, and E4. These four elements are extracted.

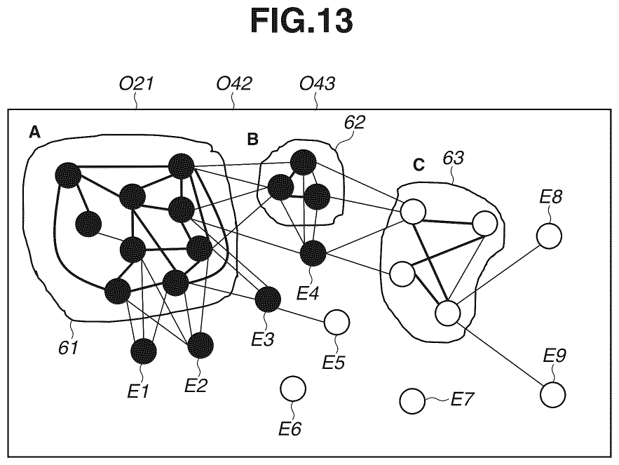

The extracted elements (16 elements) are collected into the noise-removed element list O171, and the noise-removed element list O171 is output. FIG. 13 illustrates a result. The elements included in the noise-removed element list 171 are expressed as solid black circles. In the above-described manner, the noise elements can be removed from the set of elements in which the noise elements are mixed with the signal elements, and the signal elements can be extracted with high accuracy.

Providing the second cluster selection unit has the effect of extracting signal elements that are not extracted by the existing technique. Further, a cluster of elements strongly similar to each other is created by the classification unit, which has the effect of reducing noise elements that are extracted by the existing technique. As a result, it is possible to reduce the noise included in a set of data related to a specific object.

### Second Exemplary Embodiment

In the first exemplary embodiment, the similarity used in clustering is used to calculate the core cluster belongingness (second index). However, in a case where, for example, as a result of the clustering, it is expected that the cluster A61 indicates “apparently Mr. A” and the cluster B62 indicates “apparently Mr. A wearing a mask”, use of a similarity calculated from the feature amount in a state of wearing a mask is more convenient. In other words, the similarity is desirably calculated using, in place of the feature amount used in clustering, a feature amount of a face wearing a mask, i.e., a feature amount insensitive to the texture of a mouth portion covered with a mask.

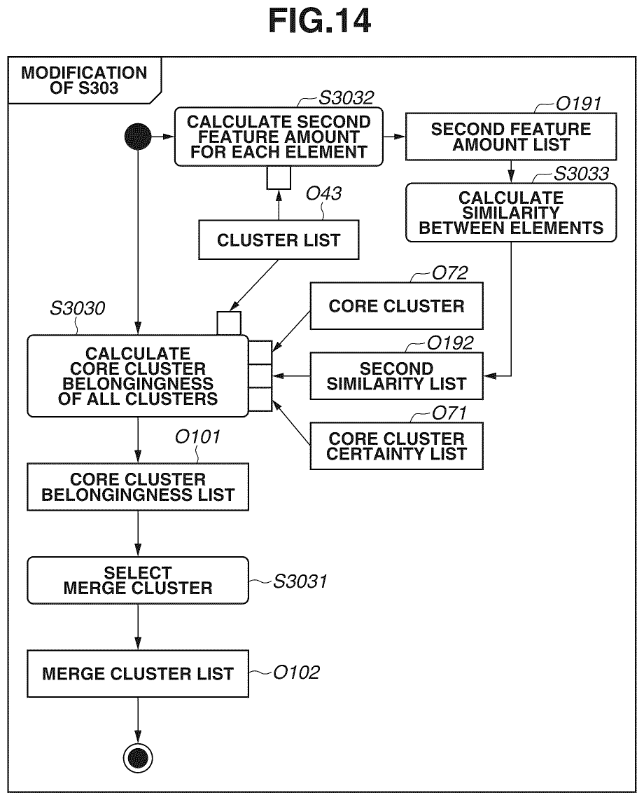

In other words, the feature amount is desirably acquired using two different calculation methods as the method of calculating the features of the elements. The second cluster selection unit 14 acquires the core cluster belongingness (second index) of each of the elements based on a feature amount acquired by a second method different from a first method. For example, when the first method is processing for extracting a feature related to a face from an entire face image, the second method may be processing for extracting a feature from an image obtained by performing predetermined conversion processing on a predetermined face region. In other words, the processing for calculating the similarity from the feature amount different from the feature amount used in clustering and calculating the core cluster belongingness may be performed by changing a part of the processing in the second cluster selection unit 14. The description is given with reference to FIG. 14. FIG. 14 is different from FIG. 9 in that the similarity list O42 is changed to a second similarity list O192, and processing for creating the second similarity list O192 is added. Therefore, only the changes are described.

In step S3032, the second cluster selection unit 14 calculates a second feature amount for each of the elements, and outputs a second feature amount list O191.

In step S3010 illustrated in FIG. 6, the feature amounts of all elements are calculated, whereas in step S3032, it is sufficient to calculate the second feature amounts of not all elements but only the elements included in the clusters. In other words, the second feature amount is calculated for each of the elements belonging to the clusters included in the cluster list O43. The elements included in the clusters are acquired from the cluster list O43.

In step S033, the second cluster selection unit 14 calculates a similarity between the second feature amounts by using the second feature amount list O191, and outputs a second similarity list O192.

In the above-described manner, in a case where a particular tendency is expected in a cluster, it is possible to extract a signal element with high accuracy by specifying a merge cluster using a feature amount matching with the tendency. In other words, it is possible to reduce the noise included in a set of data related to a specific object.

### Third Exemplary Embodiment

In the second exemplary embodiment, the core cluster belongingness is calculated based on the feature amount acquired by the plurality of feature extraction methods. At this time, the feature amount insensitive to the texture of a mouth portion covered with a mask is calculated. In a third exemplary embodiment, a feature extraction processing method for acquiring the second feature amount different from the first feature amount with a simple method without preparing a different feature extraction method is described. In a case where a feature amount extractor is trained using deep learning, it generally takes a lot of time, and a memory amount occupied by the feature amount extractor itself during feature extraction is doubled. Therefore, an image in which a part including a mouth of a face image of each element is covered is combined, and a feature amount of the combined image is calculated by the processing same as the processing used in step S3030.

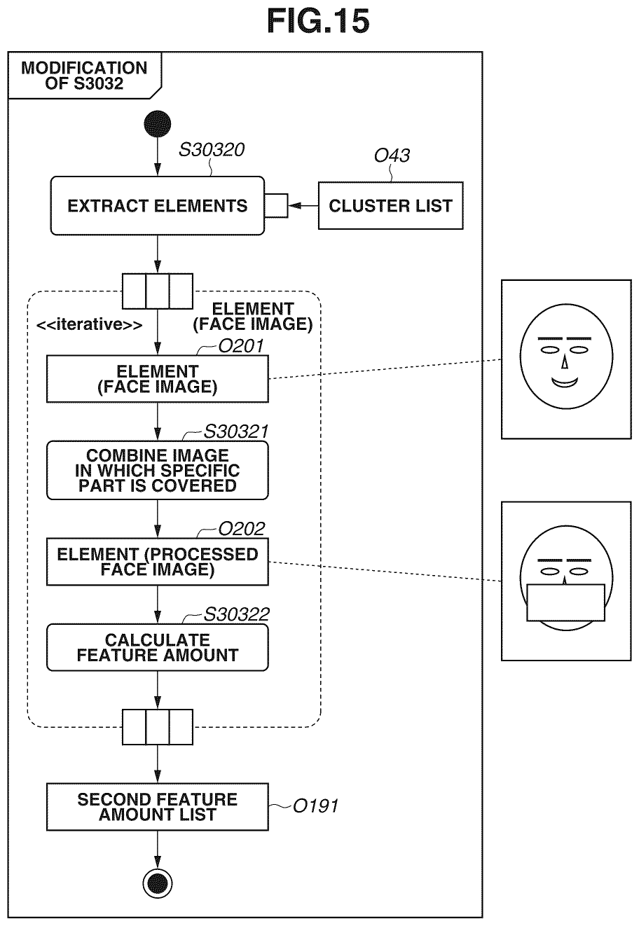

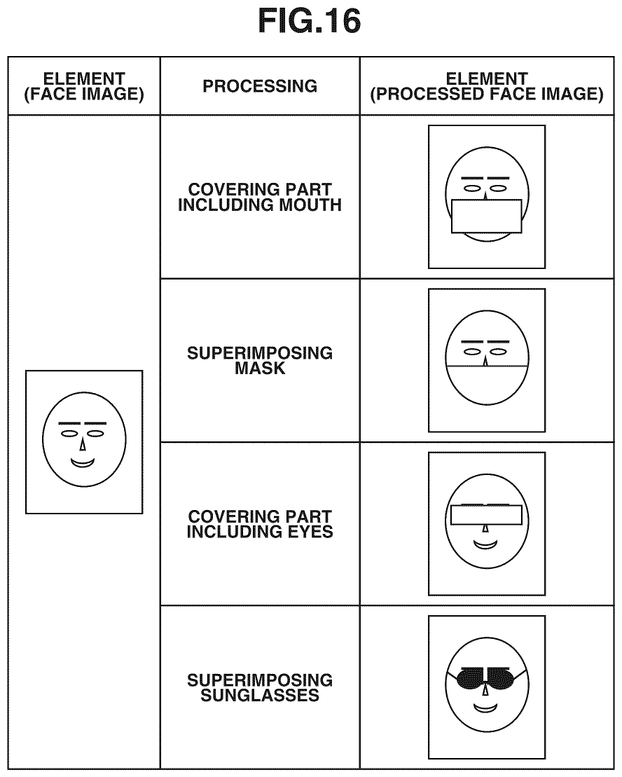

In other words, the second cluster selection unit 14 acquires the second feature amount different from the first feature amount by performing predetermined processing on each of the elements. FIG. 15 illustrates a modification of the processing in step S3032 to be performed by the second cluster selection unit 14. In step S30320, the second cluster selection unit 14 extracts elements (face images) included in each of the clusters from the cluster list O43. The feature amount of each of the extracted elements (face images) is calculated by processing in step S30321 and S30322, and results are output to the second feature amount list O191. In step S30321, the second cluster selection unit 14 performs predetermined conversion processing on the elements (face image) (O201). In the processing, a face image in which a part (specific region) including a mouth is covered is combined with the face image (O202). In step S30322, the second cluster selection unit 14 calculates the feature amount of a processed face image O202 by using a feature extraction model same as in the first feature extraction method. FIG. 16 illustrates examples of the element (face image) O201 and the element (processed face image) O202. In the present exemplary embodiment, the mouth portion is covered in step S30321 as a specific example of the specific region; however, the specific region is not limited thereto. In a case where it is expected that an image with sunglasses is obtained as a cluster, a part including eyes may be covered. Further, an image obtained by superimposing and combining a mask or sunglasses may be used in place of an image in which a part including a mouth or eyes is covered. FIG. 16 illustrates these examples. As the predetermined conversion processing, processing for masking the specific region of the element is described. The predetermined conversion processing is not limited to covering, superimposing and combining of a part including a mouth or eyes of an image. For example, a part including an earlobe may be covered, or an ear accessary may be superimposed and combined. Alternatively, processing for blurring the specific region may be performed.

In the above-described manner, even in a case where a particular tendency is expected in a cluster, it is possible to extract a signal element with high accuracy. Further, since one feature amount extractor is used, it is possible to prevent a lot of time from being taken to create the feature amount extractor, and to prevent the memory amount necessary for execution from being increased.

### Other Exemplary Embodiment

In all of the above-described exemplary embodiments, the cases related to images are described; however, the effects of the present patent are not limited to images, and therefore, the scope of the present patent is not limited to images.

The present invention is also realized by performing the following processing. That is, software (program) for realizing the functions of the above-described exemplary embodiments is supplied to a system or an apparatus through a network for data communication or various kinds of storage media. Further, a computer (or CPU, micro processing unit (MPU), etc.) of the system or the apparatus reads out and executes the program. The program may be provided by being recorded in a computer-readable recording medium.

The present invention is not limited to the above-described exemplary embodiments, and can be changed and modified in a various manner without departing from the spirit and the scope of the present invention. Therefore, to publicize the scope of the present invention, the following claims are attached.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
at least one memory storing instructions; and
at least one processor that, upon execution of the stored instructions, cause the at least one processor to:
acquire a plurality of elements;
classify the acquired elements into a plurality of clusters based on a similarity between the elements;
select a first cluster related to a predetermined object based on a first index calculated from elements included in the classified clusters;
select a second cluster based on a second index calculated from the first cluster and the elements included in the classified clusters;
specify a marge element to be merged, among the acquired elements, based on the second cluster and the first cluster; and
output a third cluster including the merge element, an element included in the first cluster, and an element included in the second cluster.

2. The information processing apparatus according to claim 1,
wherein a third index of an element included in neither the first cluster nor the second cluster among the acquired elements is calculated, and
wherein an element having the third index that is equal to or greater than a third threshold is specified as the merge element.

3. The information processing apparatus according to claim 2, wherein the third index is an index calculated based on a similarity with the element included in the first cluster and the element included in the second cluster.

4. The information processing apparatus according to claim 1, wherein a cluster is generated by extracting elements having a similarity to each other that is equal to or greater than a predetermined threshold.

5. The information processing apparatus according to claim 1, wherein the first index is a certainty indicating a possibility that a predetermined object is included, and is calculated based on at least one of a similarity between elements, a number of elements included in a cluster, and information related to an element.

6. The information processing apparatus according to claim 1, wherein, based on the first index calculated for each of the plurality of clusters, a cluster having the first index that is greater than a first threshold is selected as the first cluster.

7. The information processing apparatus according to claim 1, wherein, based on the first index calculated for each of the plurality of clusters, a cluster having the first index that is greatest is selected as the first cluster.

8. The information processing apparatus according to claim 1, wherein, based on the second index calculated for each of the plurality of clusters, a cluster having the second index that is greater than a second threshold is selected as the second cluster.

9. The information processing apparatus according to claim 1, wherein the second index is an index indicating a similarity between the first cluster and a target cluster different from the first cluster, and is calculated for each cluster.

10. The information processing apparatus according to claim 9, wherein the second index is calculated based on a similarity between the element included in the first cluster and an element included in the target cluster different from the first cluster, or the first index of the target cluster.

11. The information processing apparatus according to claim 1,
wherein the first index is calculated based on a first feature amount extracted by a first method for each of elements included in the plurality of clusters, and
wherein the second index is calculated based on a second feature amount extracted based on a second method different from the first method, for each of the elements included in the plurality of clusters.

12. The information processing apparatus according to claim 11,
wherein the elements are each a face image,
wherein the first method is processing for extracting a feature from the face image, and
wherein the second method is processing for extracting a feature from an image obtained by performing predetermined conversion processing on a specific region of the face image.

13. An information processing method comprising:
acquiring a plurality of elements;
classifying the acquired elements into a plurality of clusters based on a similarity between the elements;
selecting a first cluster related to a predetermined object based on a first index calculated from elements included in the classified clusters;
selecting a second cluster based on a second index calculated from the first cluster and elements included in the classified clusters;
specifying a marge element to be merged, among the acquired elements, based on the second cluster and the first cluster; and
outputting a third cluster including the merge element, an element included in the first cluster, and an element included in the second cluster.

14. A non-transitory computer-readable storage medium storing a program for causing a computer to execute a method, the method comprising:
acquiring a plurality of elements;
classifying the acquired elements into a plurality of clusters based on a similarity between the elements;
selecting a first cluster related to a predetermined object based on a first index calculated from elements included in the classified clusters;
selecting a second cluster based on a second index calculated from the first cluster and elements included in the classified clusters;
specifying a marge element to be merged, among the acquired elements, based on the second cluster and the first cluster; and
outputting a third cluster including the merge element, an element included in the first cluster, and an element included in the second cluster.
